(19) United States
(12) Patent Application Publication
(10) Pub. No.: US 2025/0363411 A1
(43) Pub. Date: Nov. 27, 2025

(54) Iterative Learning with Different Transmission Modes

(71) Applicant: Telefonaktiebolaget LM Ericsson (publ), Stockholm (SE)

(72) Inventors: Reza Moosavi, Linköping (SE); Henrik Rydén, Stockholm (SE); Erik G. Larsson, Linköping (SE)

(21) Appl. No.: 18/867,282

(22) PCT Filed: May 23, 2022
(86) PCT No.: PCT/EP2022/063877

§ 371 Date: Nov. 19, 2024

(51) Int. Cl. G06N 20/00

(52) U.S. Cl. CPC G06N 20/00

(57) ABSTRACT

There is provided techniques for an iterative learning process being performed between a server entity and agent entities. The iterative learning process pertains to a computational task to be performed by the agent entities. For each iteration round of the iterative learning process the server entity uses either a first transmission mode or a second transmission mode for sending a respective parameter vector of the computational task towards the agent entities. The agent entities are configured with the computational task, with which reception mode to use, and for the agent entities to, as part of performing one iteration round of the iterative learning process with the server entity, send local updates of computational results of the computational task to the server entity. The parameter vector of each iteration round is sent using either the first transmission mode or the second transmission mode.

### TECHNICAL FIELD

Embodiments presented herein relate to a method, a server entity, a computer program, and a computer program product for performing an iterative learning process with agent entities. Embodiments presented herein further relate to a method, an agent entity, a computer program, and a computer program product for performing an iterative learning process with the server entity.

### BACKGROUND

The increasing concerns for data privacy have motivated the consideration of collaborative machine learning (ML) systems with decentralized data where pieces of training data are stored and processed locally by edge user devices, such as user equipment. Federated learning (FL) is one non-limiting example of a decentralized learning topology, where multiple (possible very large number of) agents, for example implemented in user equipment, participate in training a shared global learning model by exchanging model updates with a centralized parameter server (PS), for example implemented in a network node. In general terms, FL might be regarded as an ML technique that trains an ML (or artificial intelligence; AI) model across multiple decentralized agents, each performing local model training using local data samples. The technique requires multiple interactions of the model, but no exchange of local data samples. In this respect, an ML, or AI, model might be regarded as a data driven algorithm that applies AI/ML techniques to generate a set of outputs based on a set of inputs. Therefore, AI/ML model training might be regarded as a process to train an AI/ML model by learning the input/output relationship in a data driven manner and obtain the trained AI/ML model for inference. An AI/ML model might be delivered over the air interface; either parameters of a model structure known at the receiving end or a new model with parameters. In this respect, a model download refers to model transfer from the PS to the agents, and model upload refers to model transfer from the agents to the PS.

In further details, FL is an iterative process where each global iteration, often referred to as iteration round, is divided into three phases: In a first phase the PS sends the current model parameter vector to all participating agents (i.e., performing model download). In a second phase each of the agents performs one or several steps of a stochastic gradient descent (SGD) procedure on its own training data based on the current model parameter vector and obtains a model update. In a third phase the model updates from all agents are sent to the PS (i.e., performing model upload), which aggregates the received model updates and updates the parameter vector for the next iteration based on the model updates according to some aggregation rule. The first phase is then entered again but with the updated parameter vector as the current model parameter vector.

In order to reduce the overhead for FL, one option is to multicast, or broadcast, the parameter vectors to the participating agents during each iteration round when performing the model download. That is, the parameter vector for a given iteration round is sent at the same time/space/frequency resources for all the participating agents. The parameter vector is then multicast, or broadcast, at the beginning of each iteration round. This type of transmission is expensive in terms of needed time/space/frequency resources as the parameter vector can be of large dimension. There are savings if a differential update (i.e., a partial model) is sent instead of the complete model (i.e., the full model), however, in case some given agent misses the reception of such a differential update for a certain iteration round, this given agent will neither be able to participate in the certain iteration round at hand, nor in any subsequent iteration rounds.

Hence, there is a need for further improved communication between the PS and the agents.

### SUMMARY

An object of embodiments herein is to address the above issues in order to enable efficient communication between the PS (hereinafter denoted server entity) and the agents (hereinafter denoted agent entities), especially for transmitting the parameter vectors of an iterative learning process from the PS towards the agents.

According to a first aspect there is presented a method for performing an iterative learning process, for example a machine learning iterative learning process, with agent entities, for example software agent entities. The method is performed by a server entity, for example a parameter server. The iterative learning process pertains to a computational task, for example a machine learning computational task, to be performed by the agent entities. For each iteration round of the iterative learning process the server entity uses either a first transmission mode or a second transmission mode for sending a respective parameter vector of the computational task towards the agent entities, wherein each of the first transmission mode and the second transmission mode has a corresponding reception mode. The method comprises configuring the agent entities with the computational task, with which reception mode to use, and for the agent entities to, as part of performing one iteration round of the iterative learning process with the server entity, send local updates of computational results of the computational task to the server entity, for example machine learning computational results of a machine learning computational task. The method comprises sending the parameter vector of a first iteration round of the iterative learning process to the agent entities whilst using the first transmission mode as part of performing the first iteration round. The method comprises sending the parameter vector of a second iteration round of the iterative learning process to the agent entities whilst using the second transmission mode as part of performing the second iteration round.

According to a second aspect there is presented a server entity, for example a parameter server, for performing an iterative learning process, for example a machine learning iterative learning process, with agent entities, for example software agent entities. The iterative learning process pertains to a computational task, for example a machine learning computational task, to be performed by the agent entities. For each iteration round of the iterative learning process the server entity is to use either a first transmission mode or a second transmission mode for sending a respective parameter vector of the computational task towards the agent entities, wherein each of the first transmission mode and the second transmission mode has a corresponding reception mode. The server entity comprises processing circuitry. The processing circuitry is configured to cause the server entity to configure the agent entities with the computational task, with which reception mode to use, and for the agent entities to, as part of performing one iteration round of the iterative learning process with the server entity, send local updates of computational results of the computational task to the server entity, for example machine learning computational results of a machine learning computational task. The processing circuitry is configured to cause the server entity to send the parameter vector of a first iteration round of the iterative learning process to the agent entities whilst using the first transmission mode as part of performing the first iteration round. The processing circuitry is configured to cause the server entity to send the parameter vector of a second iteration round of the iterative learning process to the agent entities whilst using the second transmission mode as part of performing the second iteration round.

According to a third aspect there is presented a server entity, for example a parameter server, for performing an iterative learning process, for example a machine learning iterative learning process, with agent entities, for example software agent entities. The iterative learning process pertains to a computational task, for example a machine learning computational task, to be performed by the agent entities. For each iteration round of the iterative learning process the server entity is to use either a first transmission mode or a second transmission mode for sending a respective parameter vector of the computational task towards the agent entities, wherein each of the first transmission mode and the second transmission mode has a corresponding reception mode. The server entity comprises a configure module configured to configure the agent entities with the computational task, with which reception mode to use, and for the agent entities to, as part of performing one iteration round of the iterative learning process with the server entity, send local updates of computational results of the computational task to the server entity, for example machine learning computational results of a machine learning computational task. The server entity comprises a send module configured to send the parameter vector of a first iteration round of the iterative learning process to the agent entities whilst using the first transmission mode as part of performing the first iteration round. The server entity comprises a send module configured to send the parameter vector of a second iteration round of the iterative learning process to the agent entities whilst using the second transmission mode as part of performing the second iteration round.

According to a fourth aspect there is presented a computer program for performing an iterative learning process with agent entities, the computer program comprising computer program code which, when run on processing circuitry of a server entity, causes the server entity to perform a method according to the first aspect.

According to a fifth aspect there is presented a method for performing an iterative learning process, for example a machine learning iterative learning process, with a server entity, for example a parameter server. The method is performed by an agent entity, for example a software agent entity. The iterative learning process pertains to a computational task, for example a machine learning computational task, to be performed by the agent entity. For each iteration round of the iterative learning process the agent entity uses either a first reception mode or a second reception mode for receiving a respective parameter vector of the computational task from the server entity. The method comprises receiving configuration from the server entity of the computational task, of which reception mode to use, and for the agent entity to, as part of performing one iteration round of the iterative learning process with the server entity, send a local update of computational results of the computational task to the server entity, for example machine learning computational results of a machine learning computational task. The method comprises receiving the parameter vector of a first iteration round of the iterative learning process from the server entity whilst using the first reception mode as part of performing the first iteration round. The method comprises receiving the parameter vector of a second iteration round of the iterative learning process from the server entity whilst using the second reception mode as part of performing the second iteration round.

According to a sixth aspect there is presented an agent entity, for example a software agent entity, for performing an iterative learning process, for example a machine learning iterative learning process, with a server entity, for example a parameter server. The iterative learning process pertains to a computational task, for example a machine learning computational task, to be performed by the agent entity. For each iteration round of the iterative learning process the agent entity is to use either a first reception mode or a second reception mode for receiving a respective parameter vector of the computational task from the server entity. The agent entity comprises processing circuitry. The processing circuitry is configured to cause the agent entity to receive configuration from the server entity of the computational task, of which reception mode to use, and for the agent entity to, as part of performing one iteration round of the iterative learning process with the server entity, send a local update of computational results of the computational task to the server entity, for example machine learning computational results of a machine learning computational task. The processing circuitry is configured to cause the agent entity to receive the parameter vector of a first iteration round of the iterative learning process from the server entity whilst using the first reception mode as part of performing the first iteration round. The processing circuitry is configured to cause the agent entity to receive the parameter vector of a second iteration round of the iterative learning process from the server entity whilst using the second reception mode as part of performing the second iteration round.

According to a seventh aspect there is presented an agent entity, for example a software agent entity, for performing an iterative learning process, for example a machine learning iterative learning process, with a server entity, for example a parameter server. The iterative learning process pertains to a computational task, for example a machine learning computational task, to be performed by the agent entity. For each iteration round of the iterative learning process the agent entity is to use either a first reception mode or a second reception mode for receiving a respective parameter vector of the computational task from the server entity. The agent entity comprises a receive module configured to receive configuration from the server entity of the computational task, of which reception mode to use, and for the agent entity to, as part of performing one iteration round of the iterative learning process with the server entity, send a local update of computational results of the computational task to the server entity, for example machine learning computational results of a machine learning computational task. The agent entity comprises a receive module configured to receive the parameter vector of a first iteration round of the iterative learning process from the server entity whilst using the first reception mode as part of performing the first iteration round. The agent entity comprises a receive module configured to receive the parameter vector of a second iteration round of the iterative learning process from the server entity whilst using the second reception mode as part of performing the second iteration round.

According to an eighth aspect there is presented a computer program for performing an iterative learning process with a server entity, the computer program comprising computer program code which, when run on processing circuitry of an agent entity, causes the agent entity to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects improve resource utilization during the transmission of a parameter vector of a learning model from the server entity to the agent entities.

Advantageously, these aspects improve the performance of the iterative learning process when having limited network resources for the iterative learning process, leading to better performance for the machine learning model.

Advantageously, these aspects enable network resource savings and energy efficiency improvements for the downlink in systems where iterative learning, such as FL, processes are run.

Advantageously, these aspects enable the parameters to be sent as a difference to one or more previously sent parameter vectors, resulting in less information to be transmitted (and hence less time/space/frequency resources for the transmission).

Advantageously, these aspects provide a revert-back mechanism in case some of the agent entities miss the transmission of the parameter vector in one or more iteration rounds.

Advantageously, these aspects can be used when selecting which agent entities that will participate in each iteration round, depending on which transmission mode is used for sending the parameter vector. This can further improve the efficiency of the iterative learning process.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a signalling diagram according to an example;

FIGS. 3, 4, 5, and 6 are flowcharts of methods according to embodiments;

FIG. 7 is a schematic illustration of part of a communication network according to embodiments;

FIG. 8 is a signalling diagram according to an embodiment;

FIG. 9 is a schematic diagram showing functional units of a server entity according to an embodiment;

FIG. 10 is a schematic diagram showing functional modules of a server entity according to an embodiment;

FIG. 11 is a schematic diagram showing functional units of an agent entity according to an embodiment;

FIG. 12 is a schematic diagram showing functional modules of an agent entity according to an embodiment;

FIG. 13 shows one example of a computer program product comprising computer readable means according to an embodiment;

FIG. 14 is a schematic diagram illustrating a telecommunication network connected via an intermediate network to a host computer in accordance with some embodiments; and

FIG. 15 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

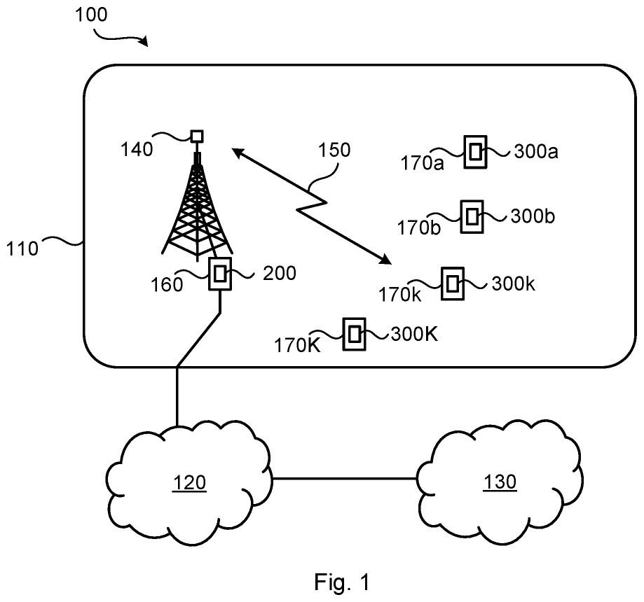

FIG. 1 is a schematic diagram illustrating a communication network 100 where embodiments presented herein can be applied. The communication network 100 could be a third generation (3G) telecommunications network, a fourth generation (4G) telecommunications network, a fifth (5G) telecommunications network, a sixth (6G) telecommunications network, and support any 3GPP telecommunications standard.

The communication network 100 comprises a transmission and reception point 140 configured to provide network access to user equipment 170a, 170k, 170K in an (radio) access network 110 over a radio propagation channel 150. The access network 110 is operatively connected to a core network 120. The core network 120 is in turn operatively connected to a service network 130, such as the Internet. The user equipment 170a:170K is thereby, via the transmission and reception point 140, enabled to access services of, and exchange data with, the service network 130.

Operation of the transmission and reception point 140 is controlled by a network node 160. The network node 160 might be part of, collocated with, or integrated with the transmission and reception point 140.

Examples of network nodes 160 are (radio) access network nodes, radio base stations, base transceiver stations, Node Bs (NBs), evolved Node Bs (eNBs), gNBs, access points, access nodes, and integrated access and backhaul nodes. Examples of user equipment 170a:170K are wireless devices, mobile stations, mobile phones, handsets, wireless local loop phones, smartphones, laptop computers, tablet computers, network equipped sensors, network equipped vehicles, and so-called Internet of Things devices.

It is assumed that the user equipment 170a:170K are to be utilized during an iterative learning process and that the user equipment 170a:170K as part of performing the iterative learning process are to report computational results to the network node 160. The network node 160 therefore comprises, is collocated with, or integrated with, a server entity 200. Hence, the server entity 200 might be part of, collocated with, or integrated with, the network node 160. Each of the user equipment 170a:170K comprises, is collocated with, or integrated with, a respective agent entity 300a:300K. Hence, each agent entity 300a:300K might be part of, collocated with, or integrated with, a respective user equipment 170a:170K. In some examples, the server entity 200 and the agent entities 300a:300K are provided in a distributed computing architecture.

Consider a system with a server entity 200 and K agent entities 300a:300K. The server entity 200 and the agent entities 300a:300K communicate over a shared medium for which broadcasting is possible, i.e., transmission of information that can be received simultaneously by several agent entities 300a:300K. A prime example of such a medium is the wireless channel, where techniques such as Long Term Evolution (LTE) and New Radio (NR) and as standardized by the third generation partnership project (3GPP). Henceforth a wireless communication medium is assumed.

A learning model is iteratively trained. The procedure for one iteration round will be summarized next. First, the server entity 200 broadcasts a parameter vector (which could be differentially to a previously broadcasted model, as detailed below). This parameter vector is assumed to be received by the agent entities 300a:300K. Each of the agent entities 300a:300K then computes a local model update based on local training data, and then sends their locally obtained updates to the server entity 200. Finally, the server entity 200 aggregates all received local updates to update the learning model.

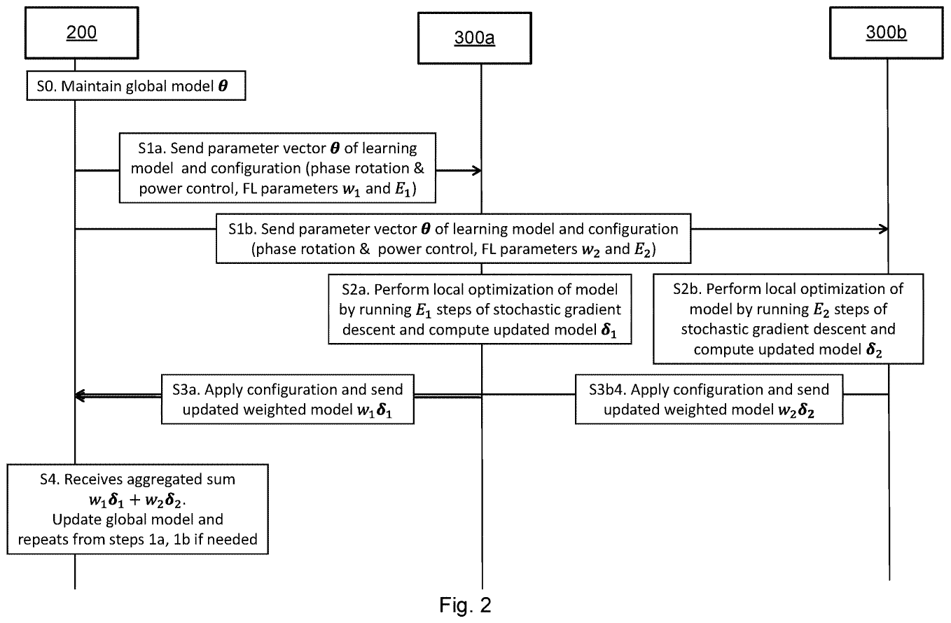

Reference is next made to the signalling diagram of FIG. 2, illustrating an example of a nominal iterative learning process. Consider a setup with K agent entities 300a:300K, and one server entity 200. Each transmission from the agent entities 300a:300K is allocated N resource elements (REs). These can be time/frequency samples, or spatial modes. For simplicity, but without loss of generality, the example in FIG. 2 is shown for two agent entities 300a, 300b, but the principles hold also for larger number of agent entities 300a:300K.

The server entity 200 updates its estimate of the learning model (maintained as a global model θ in step S0), as defined by a parameter vector θ(i), by performing global iterations with an iteration time index i. The parameter vector θ(i) is assumed to be an N-dimensional vector. At each iteration i, the following steps are performed:

Steps S1a, S1b: The server entity 200 sends the current parameter vector of the learning model, θ(i), to the agent entities 300a, 300b.

In this respect, there could be different ways in which the current parameter vector of the learning model, θ(i), is sent to the agent entities 300a, 300b, such as unicast digital transmission, broadcast transmission, or multicast transmission. Some properties of each of these types of transmissions will be disclosed next.

With unicast digital transmission, the server entity 200 allocates orthogonal time, frequency, and/or spatial, resources to each agent entity 300a, 300b. For each agent entity 300a, 300b, a corresponding transmission rate as well as coding and modulation scheme are determined. The model, or a differential update compared to the previously broadcasted model, is quantized and compressed using a source code. For each agent entity 300a, 300b, a modulation and coding scheme is applied, tailored to the rate that the channel to this agent entity 300a, 300b can support. Each agent entity 300a, 300b then decodes the transmission that contains the model (or its differential update).

With broadcast transmission, the server entity 200 transmits in such a way that all agent entities 300a, 300b can decode the model. Since the properties of the radio propagation channel 150 differ for each of the agent entities 300a, 300b, for example resulting in the pathloss being different for the different agent entities 300a, 300b, this can require that the transmission rate is selected very low (using heavy error control coding). An alternative is to use an error control code that can be decoded using only partially received bits. For example, if one uses a channel code (e.g., low density parity check codes; LDPC) with a pseudo-random structure of its parity check matrix, then the agent entities 300a, 300b with small pathloss (and therefore a high received sign al to noise ratio; SNR) may decode the model broadcast after receiving a relatively small number of bits. In contrast, agent entities 300a, 300b with a higher pathloss will have to receive more parity bits before decoding is possible. Agent entities experiencing a comparatively high SNR (compared to other agent entities) could not only decode the model faster but also start their training computation (e.g., stochastic gradient) earlier, hence enabling a reduction in clock frequency of the computation which in turn results in lower power consumption.

With multicast transmission, the agent entities 300a, 300b can be partitioned in different groups, where one respective uplink pilot resource is assigned per each group. In this way, when beamformed transmission is used, multiple beams can be used, where each beam is adapted to serve a particular group of agent entities 300a, 300b. Multicast transmission might be regarded as a combination of unicast and broadcast techniques and there may be circumstances where such grouping is preferable for performance reasons.

Steps S2a, S2b: Each agent entity 300a, 300b performs a local optimization of the model by running T steps of a stochastic gradient descent update on θ(i), based on its local training data;

$${θ}_{k} ( i , τ ) = {θ}_{k} ( i , τ - 1 ) - {η}_{k} ∇ {f}_{k} ( {θ}_{k} ( i , τ - 1 ) ) τ = 1 , … , T ,$$

where ηₖ is a weight and fₖ is the objective function used at agent entity k (and which is based on its locally available training data).

Steps S3a, S3b: Each agent entity 300a, 300b transmits to the server entity 200 their model update δₖ(i);

$${δ}_{k} ( i ) = {θ}_{k} ( i , T ) - {θ}_{k} ( i , 0 ) ,$$

where θₖ(i, 0) is the model that agent entity k received from the server entity 200. Steps S3a, S3b may be performed sequentially, in any order, or simultaneously.

Step S4: The server entity 200 updates its estimate of the parameter vector θ(i) by adding to it a linear combination (weighted sum) of the updates received from the agent entities 300a, 300b;

$$θ ( i + 1 ) = θ ( i ) + {w}_{1} {δ}_{1} ( i ) + {w}_{2} {δ}_{2} ( i )$$

where wₖ are weights.

Assume now that there are K agent entities and hence K model updates. When the model updates {δ₁, . . . , δ_{K}} (where the time index has been dropped for simplicity) from the agent entities 300a:300K over a wireless communication channel, there are specific benefits of using direct analog modulation. For analog modulation, the k:th agent entity could transmit the N components of δₖ directly over N resource elements (REs). Here an RE could be, for example: (i) one sample in time in a single-carrier system, or (ii) one subcarrier in one orthogonal frequency-division multiplexing (OFDM) symbol in a multicarrier system, or (iii) a particular spatial beam or a combination of a beam and a time/frequency resource.

One benefit of direct analog modulation is that the superposition nature of the wireless communication channel can be exploited to compute the aggregated update, δ₁+δ₂+ . . . +δ_{K}. More specifically, rather than sending δ₁, . . . , δ_{K} to the server entity 200 on separate channels, the agent entities 300a:300K could send the model updates {δ₁, . . . , δ_{K}} simultaneously, using N REs, through linear analog modulation. The server entity 200 could then exploit the wave superposition property of the wireless communication channel, namely that {δ₁, . . . , δ_{K}} add up “in the air”. Neglecting noise and interference, the server entity 200 would thus receive the linear sum, δ₁+δ₂+ . . . +δ_{K}, as desired. That is, the server entity 200 ultimately is interested only in the aggregated model update δ₁+δ₂+ . . . +δ_{K}, but not in each individual parameter vector {δ₁, . . . , δ_{K}}. This technique can thus be referred to as iterative learning with over-the-air computation.

The over-the-air computation assumes that appropriate power control is applied (such that all transmissions of {δₖ} are received at the server entity 200 with the same power), and that each transmitted δₖ is appropriately phase-rotated prior to transmission to pre-compensate for the phase rotation incurred by the channel from agent entity k to the server entity 200.

One benefit of the thus described over-the-air computation is the savings of radio resources. With two agent entities (K=2), 50% resources are saved compared to standard FL since the two agent entities can send their model updates simultaneously in the same RE. With K agent entities, only a fraction 1/K of the nominally required resources are needed.

As disclosed above, in case any parameter vector is sent as differentials to a previously sent parameter vector, if some given agent entity misses the reception of such a differential update for a certain iteration round, this given agent will neither be able to participate in the certain iteration round at hand, nor in any subsequent iteration rounds.

Further in this respect, when broadcasting in the downlink, such differential transmission of the parameter vectors assumes that there is a mechanism by which the server entity 200 can reach all agent entities 300a:300K, although in practice and in any given iteration round some of the agent entities 300a:300K may fail in decoding the signal broadcast by the server entity 200. This can be due for example to fading of the radio channel and/or blocking (e.g., at millimeter wave). Therefore, in a given iteration round, when computing its local model update, each of the agent entities 300a:300K may either have access to the latest model or only to an older model.

At least some of the herein disclosed embodiments are therefore based on that the server entity 200 switches between different transmission modes when transmitting the parameter vector in different iteration rounds. The embodiments disclosed herein in particular relate to techniques for a server entity 200 to perform an iterative learning process with agent entities 300a:300K and for an agent entity 300k to perform an iterative learning process with the server entity 200. In order to obtain such techniques there is provided a server entity 200, a method performed by the server entity 200, a computer program product comprising code, for example in the form of a computer program, that when run on processing circuitry of the server entity 200, causes the server entity 200 to perform the method. In order to obtain such techniques there is further provided an agent entity 300k, a method performed by the agent entity 300k, and a computer program product comprising code, for example in the form of a computer program, that when run on processing circuitry of the agent entity 300k, causes the agent entity 300k to perform the method.

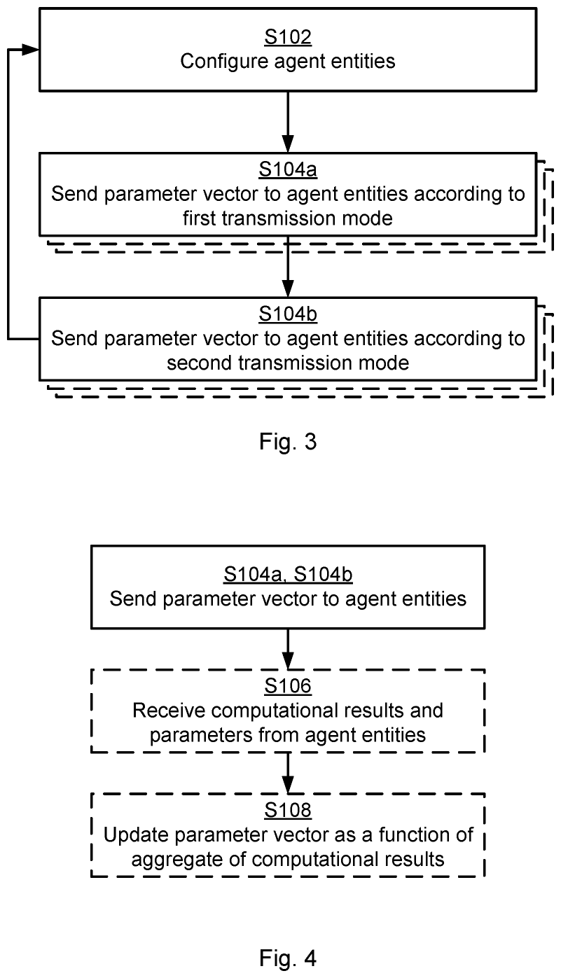

Reference is now made to FIG. 3 illustrating a method for performing an iterative learning process, for example a machine learning iterative learning process, with agent entities 300a:300K, for example software agent entities, as performed by the server entity 200, for example a parameter server, according to an embodiment. The iterative learning process pertains to a computational task, for example a machine learning computational task, to be performed by the agent entities 300a:300K. For each iteration round of the iterative learning process the server entity 200 uses either a first transmission mode or a second transmission mode for sending a respective parameter vector of the computational task towards the agent entities 300a:300K. Each of the first transmission mode and the second transmission mode has a corresponding reception mode.

The server entity 200 configures the agent entities 300a:300K. In particular, the server entity 200 is configured to perform step S102.

S102: The server entity 200 configures the agent entities 300a:300K with the computational task, with which reception mode to use, and for the agent entities 300a:300K to, as part of performing one iteration round of the iterative learning process with the server entity 200, send local updates of computational results of the computational task to the server entity 200, for example machine learning computational results of a machine learning computational task.

The server entity 200 then, for each iteration round, sends the parameter vector. The parameter vector is sent whilst using either the first transmission mode or the second transmission mode. Without loss of generality, it is assumed that the first transmission mode is used for a first iteration round and that the second transmission mode is used for a second iteration round. In particular, the server entity 200 is configured to perform step S104a and step S104b.

S104a: The server entity 200 sends the parameter vector of a first iteration round of the iterative learning process to the agent entities 300a:300K whilst using the first transmission mode as part of performing the first iteration round.

S104b: The server entity 200 sends the parameter vector of a second iteration round of the iterative learning process to the agent entities 300a:300K whilst using the second transmission mode as part of performing the second iteration round.

Embodiments relating to further details of performing an iterative learning process with agent entities 300a:300K as performed by the server entity 200 will now be disclosed.

Aspects relating to the first transmission mode and the second transmission mode will be disclosed next.

In some aspects, the parameter vector represents the full model of the computational task when the first transmission mode is used. In particular, in some embodiments, according to the first transmission mode, the parameter vector is sent without reference to any parameter vector of any previous iteration round. This implies that the full model is sent.

In some aspects, the parameter vector represents a difference between a current model and some previous model (at predetermined number of iteration rounds back in time) of the computational task when the second transmission mode is used. In particular, in some embodiments, according to the second transmission mode the parameter vector is sent as a difference to the parameter vector of at least one previous iteration round. This implies that a partial model is sent. Further, in some embodiments, according to the second transmission mode the parameter vector is sent either as a first-level difference to the parameter vector of at least one previous iteration round or as a second-level difference to the first-level difference of this at least one previous iteration round. In this respect, there might be yet further levels of differentiation, hence involving transmission of a third-level difference, etc.

In some aspects, different levels of quantization are applied to the differential updates. In particular, in some embodiments, the parameter vector sent as the second-level difference is quantized more coarsely than the parameter vector sent as the first-level difference. Different levels of quantization can thus be applied to the differential updates. For example, for parameter vectors sent as differentials, coarser quantization can be used to save downlink bandwidth.

In some aspects, when sending the parameter vector, the server entity 200 determines a transmit power and a coding and modulation scheme. In some examples, the transmit power is always selected as the maximum permitted transmit power. In another example, it is first determined which of the agent entities 300a:300K that should be reached with the transmission and with what probability. Based on that the transmit power is adapted accordingly. In yet another example, the transmit power is selected based on cell configuration and/or network requirements such as limitation on the level of interference to neighboring cells/adjacent frequencies. In some embodiments, according to the first transmission mode the parameter vector is sent using higher transmission power and/or higher error protection using a more robust modulation and coding scheme than according to the second transmission mode. For example, according to the first transmission mode, a channel error correction code with lower code rate (i.e., more parity bits) and/or a lower modulation order than the second transmission mode can be used for the transmission of the parameter vector. The parameter vectors as sent using the first transmission mode can thus be encoded with more robust error protection that the parameter vectors as sent using the second transmission mode, thereby increasing the chances of the agent entities 300a:300K receiving the parameter vectors as sent using the first transmission mode.

Aspects relating to for which iteration rounds the first transmission mode is to be used and for which iteration rounds the second transmission mode is to be used will be disclosed next.

In some aspects, the server entity 200 periodically switches between using the first transmission mode and using the second transmission mode. Hence, in some embodiments, the server entity 200 periodically switches between the first transmission mode and the second transmission mode.

In other aspects, for each iteration round the server entity 200 obtains information based on which the transmission mode for at least one upcoming iteration round is selected. Hence, in some embodiments, which of the first transmission mode and the second transmission mode to use for a given iteration round of the iterative learning process is by the server entity 200 selected as a function of at least one obtained parameter. Based on this at least one parameter, the server entity 200 might thus decide which transmission mode to use when sending the parameter vector to the agent entities 300a:300K in one or more upcoming iteration rounds.

There could be different such parameter obtained by the server entity 200.

In some embodiments, the at least one parameter pertains to properties of a propagation channel between the server entity 200 and the agent entities 300a:300K. In some non-limiting examples, the properties of the propagation channel relate to estimates of the propagation channels, and/or their long-term statistics, which includes for example, path loss, and/or the probability of blocking. In general, this information can be estimated based on uplink data from previous iteration rounds. For example, either pilot signals (such as reference signals) and/or data transmitted by the agent entities 300a:300K (or by the user equipment 170a:170K) in previous iteration rounds can be used to determine an estimate of the pathloss. Channel quality information gathered over multiple iteration rounds can be used to determine an estimate of the probability of link blockage.

In some embodiments, the at least one parameter pertains to status reports received from the agent entities 300a:300K. The status report from a given agent entity 300k might comprise any, or any combination of: an indication of the parameter vector most recently received by that given agent entity 300k, convergence of the computational task, whether the given agent entity 300k has been able to correctly decode the parameter vector most recently sent by the server entity 200. This enables the decision of which transmission mode to use when sending the parameter vector to the agent entities 300a:300K in one or more upcoming iteration rounds to be based on information about which model agents have access to, model convergence, and/or number of agents able to correctly decode models. This information may take the form of an index indicating which the latest decoded model was, or an index indicating which of the latest decoded model(s) that have been stored. The server entity 200 might obtain this information by first sending an inquiry to the agent entities 300a:300K, or the information might by the agent entities 300a:300K be reported along with their locally computed computational results to the server entity 200.

In yet further examples, the status report from a given agent entity 300k might comprise a unique identifier of the computational task, such as the ML model-ID. The identifier can be derived using information associated to the computational task or algorithm configuration parameters. For example, the identifier could be a hashed value of the model parameters that identifies the computational task.

In yet further examples, the status report from a given agent entity 300k might comprise an iterative learning process identifier and identifier of the iteration round of the iterative learning process. This information could be useful in case multiple simultaneous iterative learning processes are ongoing at the agent entities 300a:300K.

In yet further examples, the status report from a given agent entity 300k might comprise an indication of measured, or estimated, performance of the iterative learning process. This indication might be given in terms of accuracy or precision. This indication could be represented by average values, standard deviation, maximum or minimum value, etc. This information could be used by the server entity 200 to select which of the agent entities 300a:300K that are to be participating in the next upcoming iteration round of the iterative learning process.

In yet further examples, the status report from a given agent entity 300k might comprise any, or any combination of: Information associated to which network node, or radio cell, that has instantiated, or configured, the given agent entity 300k with the computational task. This information could be used by the server entity 200 to find network nodes from which the server entity 200 might retrieve UE model information.

In yet further examples, the status report from a given agent entity 300k might comprise an indication that the given agent entity 300k requests the first transmission mode to be used for the next upcoming iteration round.

In some embodiments, each of the agent entities 300a:300K is associated with a data importance score, and the at least one parameter pertains to how many of the agent entities 300a:300K with data importance score higher than a threshold value that have failed to correctly decode the parameter vector most recently sent by the server entity 200 using the second transmission mode. This enables the server entity 200 to determine which transmission mode to use based on how many agent entities 300a:300K that have a high data importance score and have failed in decoding a parameter vector sent using the second transmission mode. In further detail, the data importance score might reflect how unique the training data per each particular agent entity 300a:300K is. A high score thereby means that the agent entity 300a:300K in question has access to more unique data, and a low score means that the agent entity 300a:300K has access to less unique data. When determining which transmission mode to use, the server entity 200 might thus consider how many agent entities 300a:300K that have a high data importance score and have failed in decoding a differential update in the past. For example, for each agent entity 300a:300K, the server entity 200 may apply a predetermined function that maps the data importance score and the age of the last successfully decoded model onto a priority value. The server entity 200 may then determine that if the number of agent entities 300a:300K that have a priority value that exceeds some predetermined threshold exceeds a predetermined critical value, then the first transmission mode should be used for the next upcoming iteration round.

In some aspects, the server entity 200 consider the convergence performance of the iterative learning process in past iteration rounds. For example, the server entity 200 may observe the model residual (objective function) and determine whether or not the model residual decreases at a foreseen speed. If not, the server entity 200 may check how many of the agent entities 300a:300K are operating on old parameter vectors (due to failures in the decoding of recently sent parameter vectors) and determine that the first transmission mode is to be used for an upcoming iteration round such that all the agent entities 300a:300K gain access to the complete parameter vector. In some aspects, the server entity 200 selects to schedule only a subset of the agent entities 300a:300K to participate in an upcoming iteration round. Only scheduled agent entities 300a:300K are then considered when determining whether to use the first transmission mode or the second transmission mode.

In some aspects, the server entity 200 predetermines for which iteration rounds the first transmission mode is to be used, and for which iteration rounds the second transmission mode is to be used. Hence, in some embodiments, which of the first transmission mode and the second transmission mode to use for each of the iteration rounds is collectively selected for at least two iteration rounds.

In some examples, there are two or more consecutive iteration rounds where the second transmission mode is used between each iteration round where the first transmission mode is used. Hence, in some embodiments, the second transmission mode is used for at least two consecutive iteration rounds. An example of this will be disclosed next.

As a non-limiting and illustrative example, let t denote time and define an iteration round index, and let θ(t) the parameter vector to be sent from the server entity 200 at time t. Assume further that a differential update of the parameter vector can be sent hierarchically in time. At times t=0, 100, 200, 300, . . . the complete parameter vector θ(t) is sent. At times t=10, 20, 30, . . . , 90, 110, 120, . . . , 190, 210, 220, . . . a first-level differential update is sent, comprising the difference between the current parameter vector and the most recently sent first-level differential update. For example, at time t=30, the difference between θ(30) and θ(20) is sent. At times t=1, 2, 3, . . . , 9, 11, 12, 13, . . . , 19, 21, 22, 23, . . . , 29, 31, . . . a second-level differential update is sent, comprising the difference between the current parameter vector and the most recently sent second-level differential update. For example, at time t=7, the difference between θ(7) and θ(6) is sent. In this way, the parameter vectors that are sent most frequently are require the least amount of network resources, the updates that are sent less frequently are sent with more network resources, and the complete parameter vector (which is sent seldomly) requires most network resources. An agent entity 300a:300K that can decode every transmission of the parameter vector will always have access to the most recent model of the iterative learning process. An agent entity 300a:300K that misses an occasional second-level update (a relatively frequent event) must wait only until the next first-level update. For example, assume that one of the agent entities 300a:300K misses the parameter vector sent at time t=8. The agent entity will then have to use the parameter vector sent at time t=7 until time t=10, in which the agent entity again can rely on the first-level update and on its knowledge of θ(0) to recover θ(10). Similarly, an agent entity that misses a first-level update (which should happen less frequently, first because there are fewer such updates and second, because these updates can be coded with more error protection) will have to use the last known parameter vector until the next complete parameter vector is sent. For example, assume that an agent entity misses the parameter vector sent at time t=30. This agent entity will have to rely on the parameter vector sent at time t=29 until the next complete parameter vector is sent at time t=100. Moreover, any agent entity 300a:300K not participating in a certain iteration round (e.g., due to a limitation in number of agent entities 300a:300K participating in each iteration round) might still be configured to receive the differential, to have the most recent parameter vector when participating in the iterative learning process in a subsequent iteration round. It is here appreciated that, as discloses above, there might be yet further levels of differentiation, hence involving transmission of a third-level difference, etc. It is here also appreciated that the numerical values in the example where selected only for the sake of illustration, and other periodicities can be used, i.e., use every M:th and every N:th instead of every 10:th and every 100:th, for example, for some predetermined integers M and N.

In some aspects, the server entity 200 decides adaptively whether to use the first transmission mode or the second transmission mode (and then whether the parameter vector is to be sent as a first-level difference or as a second-level difference, etc. Hence, in some embodiments, which of the first transmission mode and the second transmission mode to use for each of the iteration rounds is individually selected per each of the iteration rounds. As an example, the server entity 200 might send the parameter vector together with a tag T, where T=0 means that the parameter vector is sent without reference to any previous parameter vector, where T=1 means that the parameter vector is sent as a first-level difference, and so on. To make the decision, the server entity 200 might consider for each of the agent entities 300a:300K which parameter vector that the agent entities 300a:300K have available. The server entity 200 might also consider, for example based on the status reports, for each particular agent entity the likelihood that the agent entity will succeed in decoding the transmission. Hence, in some embodiments, for how many consecutive iteration rounds the second transmission mode is used depends on the aforementioned at least one parameter. In some examples, if the second transmission mode has been used and more than a predetermined number of the agent entities 300a:300K have failed decoding the parameter vector at least a predetermined number of times, then the server entity 200 switches to instead use the first transmission mode for sending the parameter vector for at least one iteration round.

In some aspects, the configuration further comprises an indication that the agent entities 300a:300K should buffer, or store, a certain parameter vector, or only after a differential (as defined by a later sent parameter vector) has been added. This can be based on the number of participating agent entities 300a:300K. If a substantial amount of agent entities 300a:300K are participating in the iterative learning process, the server entity 200 might send an indication for the agent entities 300a:300K to buffer, or store, a certain parameter vector. This parameter vector can then be used as a reference when parameter vectors are sent as differentials in subsequent iteration rounds. The agent entities 300a:300K might to the server entity 300 therefore signal an indication of the number of parameter vectors that can be buffered, or stored. This information can be used by the server entity 200 to select the frequency of sending the indication that the agent entities 300a:300K should buffer, or store, a certain parameter vector.

In some aspects, the server entity 200 determines in which parts of the system the first transmission mode is to be used and in which parts of the system the second transmission mode is to be used. In particular, in some embodiments, the agent entities 300a:300K are divided into at least two subsets, and which of the first transmission mode and the second transmission mode to use for each of the iteration rounds is individually selected per each of the at least two subsets. This might, for example, be accomplished by dividing the cells in which the user equipment 170a:170K are served into a number of Multimedia Broadcast multicast service Single Frequency Network (MBSFN) areas defined in LTE and NR based telecommunication systems or Evolved-Multimedia Broadcast/Multicast Service (E-MBMS) areas defined in LTE based telecommunication systems. Hence, in some embodiments, each of the at least two subsets is served in a respective MBSFN area (or E-MBMS area). The division of agent entities 300a:300K into subsets could be based on how many of the agent entities 300a:300K per each cell that shares the same sent parameter vector. For example, neighboring cells where at least N agent entities have access to a certain parameter vector can be grouped, and then a differential with respect to that parameter vector can be sent by the server entity 200 to those N agent entities.

In some aspects, the server entity 200 jointly selects which transmission mode to use and which agent entities 300a:300K to schedule for a given iteration round, or sets of iteration rounds. For example, consider a system with 20 agent entities. The server entity 200 may decide that for each iteration round, there is no need to schedule all the 20 agent entities (for instance due to prior knowledge about the importance of the local data accessible by each agent entity or due to lack of resources in the uplink for receiving the local updates from all agent entities per each iteration round). According to a first alternative, the server entity 200 selects agent entities 1 to 5 to participate at time t, agent entities 6 to 10 to participate at time t+1, agent entities 11 to 15 to participate at time t+2, agent entities 16 to 20 to participate at time t+3, and agent entities 1 to 5 to again participate at time t+4, and so on. In this case, all the 20 agent entities do not need to update their local model at each iteration round, but only those that are participating in the iterative learning process during a specific iteration round should update their local models. Therefore, the server entity 200 might use the second transmission mode at time t+4·k, where k>0 is an integer. According to a second alternative, the server entity 200 selects agent entities 1 to 5 to participate in each iteration round but agent entities 6 to 20 to only participate in every fifth iteration round. According to this alternative, at times t=0, 5, 10, . . . the first transmission mode is used whilst for all other iteration rounds, the second transmission mode is used.

Aspects of how the at least one iteration of the iterative learning process can be performed will be disclosed next. Particular reference is here made to the flowchart of FIG. 4 showing optional steps of one iteration round of the iterative learning process that might be performed by the server entity 200 during each iteration round of the iterative learning process.

S104a/S104b: The server entity 200 sends the parameter vector of the computational task to the agent entities 300a:300K. As disclosed above, the parameter vector per each iteration round is sent using either the first transmission mode or the second transmission mode.

S106: The server entity 200 receives the computational results as a function of the parameter vector from the agent entities 300a:300K. As disclosed above, the server entity 200 might optionally receive status reports from the agent entities 300a:300K.

S108: The server entity 200 updates the parameter vector as a function of an aggregate of the received computational results. As disclosed above, the server entity 200 might optionally update which transmission mode to use for one or more upcoming iteration rounds based on the received status reports.

Steps S104a/S104b, S106, S108 can be repeated until a termination criterion is met. The termination criterion in some non-limiting examples can be when a pre-determined number of iterations have been reached, when an aggregated loss function has reached a desired value, or when the aggregated loss function does not decrease after one (or several round) of iterations. The loss function itself represents a prediction error, such as mean square error or mean absolute error.

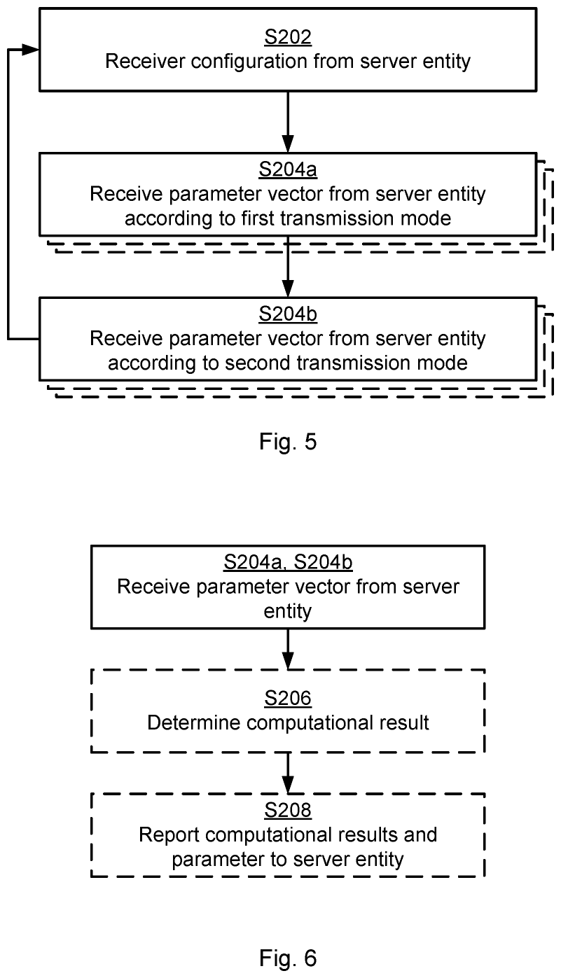

Reference is now made to FIG. 5 illustrating a method for performing an iterative learning process, for example a machine learning iterative learning process, with a server entity 200, for example a parameter server, as performed by the agent entity 300k, for example a software agent entity, according to an embodiment. The iterative learning process pertains to a computational task, for example a machine learning computational task, to be performed by the agent entity 300k. For each iteration round of the iterative learning process the agent entity 300k uses either a first reception mode or a second reception mode for receiving a respective parameter vector of the computational task from the server entity 200.

As disclosed above, the server entity 200 in step S102 configures the agent entities 300a:300K. Hence, the agent entity 300k is configured to perform step S202.

S202: The agent entity 300k receives configuration from the server entity 200 of the computational task, of which reception mode to use, and for the agent entity 300k to, as part of performing one iteration round of the iterative learning process with the server entity 200, send a local update of computational results of the computational task to the server entity 200, for example machine learning computational results of a machine learning computational task.

As disclosed above, the server entity 200 then, for each iteration round, sends the parameter vector. The parameter vector is sent whilst using either the first transmission mode or the second transmission mode. Since each of the first transmission mode and the second transmission mode has a corresponding reception mode, the agent entity 300k is configured to perform step S204a and step S204b.

S204a: The agent entity 300k receives the parameter vector of a first iteration round of the iterative learning process from the server entity 200 whilst using the first reception mode as part of performing the first iteration round.

S204b: The agent entity 300k receives the parameter vector of a second iteration round of the iterative learning process from the server entity 200 whilst using the second reception mode as part of performing the second iteration round.

Embodiments relating to further details of performing an iterative learning process with a server entity 200 as performed by the agent entity 300k will now be disclosed.

As disclosed above, in some aspects, the parameter vector represents the full model of the computational task when the first transmission mode is used. Therefore, in some embodiments, according to the first reception mode, the parameter vector is received without reference to any parameter vector of any previous iteration round.

As disclosed above, in some aspects, the parameter vector represents a difference between a current model and some previous model of the computational task when the second transmission mode is used. Therefore, in some embodiments, according to the second reception mode, the parameter vector is received as a difference to the parameter vector of at least one previous iteration round. In order to recreate the complete parameter vector, the agent entity 300k then needs to add the parameter vector of the current iteration round to the lastly recreated complete parameter vector. In further accordance with the above, in some embodiments, according to the second reception mode, the parameter vector is received either as a first-level difference to the parameter vector of at least one previous iteration round or as a second-level difference to the first-level difference of said at least one previous iteration round.

As disclosed above, in some aspects, the configuration further comprises an indication that the agent entities 300a:300K should buffer, or store, a certain parameter vector, or only after a differential (as defined by a later sent parameter vector) has been added. Hence, the agent entity 300k might either store parameter vector that are sent without any reference to any other parameter vector, or upon having also received a differential. This can further reduce the memory consumed by the agent entity 300k. The agent entity 300k might to the server entity 300 therefore signal an indication of the number of parameter vectors that can be buffered, or stored.

As disclosed above, in some aspects, the agent entity 200 periodically switches between the first transmission mode and the second transmission mode. Therefore, in some embodiments, according to the configuration from the server entity 200, the agent entity 300k is to periodically switch between the first reception mode and the second reception mode.

As disclosed above, in some aspects, the decision regarding which transmission mode is to be used is based on status report received by the server entity 200 from the agent entities 300a:300K. Hence, in some embodiments, according to the configuration from the server entity 200, the agent entity 300k is requested to send a status report to the server entity 200, wherein the status report indicates the parameter vector most recently received by the agent entity 300k, convergence of the computational task, and/or whether the agent entity 300k has been able to correctly decode the parameter vector most recently received from the server entity 200.

As disclosed above, in some aspects, the decision regarding which transmission mode is to be used is made per each of the iteration rounds. Hence, in some embodiments, the configuration of which reception mode to use by the agent entity 300k is received per each of the iteration rounds. However, as further disclosed above, in other aspects, the decision regarding which transmission mode is to be used is made per at least two iteration rounds. Hence, in some embodiments, the configuration of which reception mode to use by the agent entity 300k is received per at least two iteration rounds.

As disclosed above, in some aspects, several consecutive iteration rounds where the second transmission mode is used are performed before the first transmission mode is used again. Hence, in some embodiments, the second reception mode is by the agent entity 300k used for at least two consecutive iteration rounds.

As disclosed above, in some aspects, how many consecutive iteration rounds of the second transmission mode that are performed before a switch back to the first transmission mode is a function of the status reports sent by the agent entities 300a:300K. Hence, in some embodiments, for how many consecutive iteration rounds the second reception mode is used depends on the status report sent by the agent entity 300k.

Reference is next made to the flowchart of FIG. 6 showing optional steps of one iteration round of the iterative learning process that might be performed by the agent entity 300k during each iteration round of the iterative learning process.

S204a/S204b: The agent entity 300k receives a parameter vector of the computational problem from the server entity 200. As disclosed above, the parameter vector per each iteration round is received using either the first reception mode or the second reception mode.

S206: The agent entity 300k determines the computational result of the computational task as a function of the received parameter vector for the iteration and of data locally obtained by the agent entity 300k.

S208: The agent entity 300k reports the computational result to the server entity 200. As disclosed above, the agent entity 300k might optionally send a status report to the server entity 200.

Steps S204a/S204b, S206, S208 can be repeated until a termination criterion is met. The termination criterion in some non-limiting examples can be when a pre-determined number of iterations have been reached, when an aggregated loss function has reached a desired value, or when the aggregated loss function does not decrease after one (or several round) of iterations. The loss function itself represents a prediction error, such as mean square error or mean absolute error.

In summary, the server entity 200 might for one or more iteration round determine whether to use the first transmission mode or a second transmission mode, where, according to the first transmission mode the parameter vector is sent without reference to any parameter vector of any previous iteration round, and where, wherein according to the second transmission mode the parameter vector is sent as a difference to the parameter vector of at least one previous iteration round. For example, if θ(t) denotes the model at time t, then the server entity at time t can determine to send either θ(t) or θ(t)−θ(t−T) for some value of T>0, depending on the scenario. The differential θ(t)−θ(t−T) can be regarded as a model gradient, where a certain step size has already been applied, or signalled as part of the differential. In some examples, before each iteration round, the server entity 200 might inquire at least some of the agent entities 300a:300K for a status report. The decision by the server entity 200 what transmission mode to use might then be based on any received status reports and/or properties of the propagation channels between the server entity 200 and the agent entities 300a:300K.

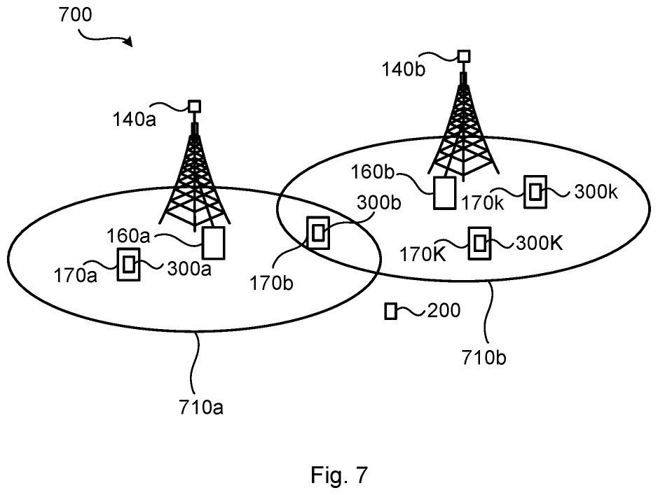

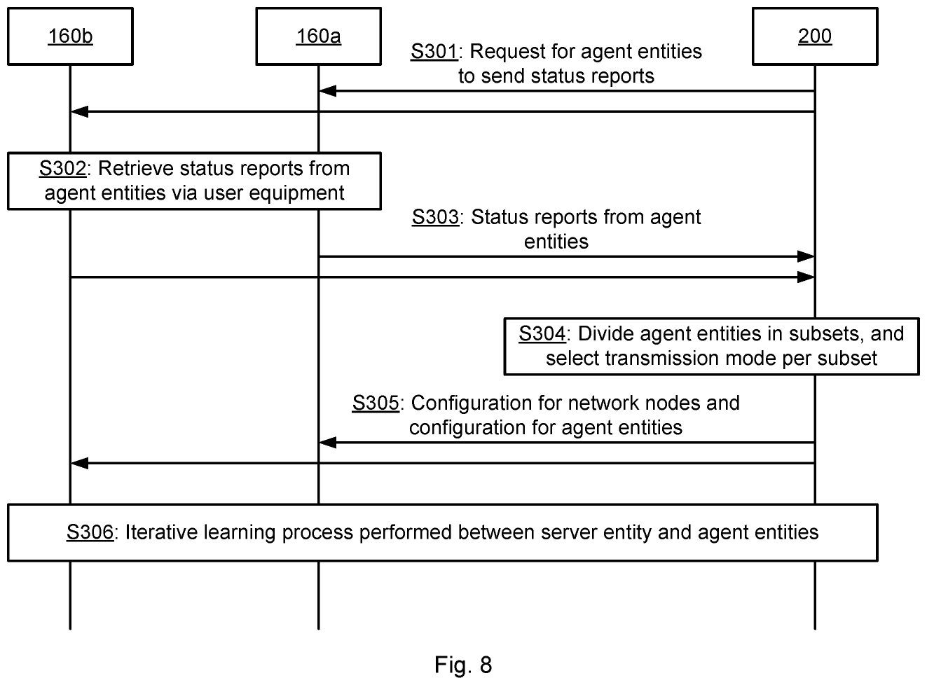

One example for the server entity 200 and the agent entities 300a:300K to perform an iterative learning process based on at least some of the above disclosed embodiments will now be disclosed in detail with reference to the communication network of FIG. 7 and the signalling diagram of FIG. 8.

The present example is based on a communication network supporting MBSFN operation. In FIG. 7 is illustrated an example of a communication network 700, showing parts of communication network 100 in FIG. 1 but where there are two network nodes 160a, 160b, each with its own transmission and reception point 140a, 140b. Each network node 160a, 160b is serving a respective cell 710a, 710b. The cells 710a, 710b collectively define the coverage region of the (radio) access network 110. For illustrative purposes, it is assumed that cell 710a serves a first MBSFN area and cell 710b serves a second MBSFN area. User equipment 170b located in an overlap between the cells 710a, 710b might belong to either the first MBSFN area or the second MBSFN area, depending on whether user equipment 170b is served by network node 160a or network node 160b. However, in general terms, the server entity 200 can base the MBSFN areas on which parameter vector the agent entities 300a:300K lastly have received. If a majority of agent entities 300a:300K in the user equipment served in a given cell 710a, 710b have not received the lastly sent parameter vector, it can be advantageous to perform a MBSFN transmission where the parameter vector is sent according to the first transmission mode, since this can improve the signal to interference ratio (SIR) of the reception. This can enable more agent entities to participate in the iterative learning process.

S301: The server entity 200 requests the agent entities 300a:300K to send status reports. The request is sent to the network nodes 160a, 160b, which forwards the request to the user equipment 170a:170K served in its cells. The agent entities 300a:300K in each of the user equipment 170a:170K thereby receive the request.

S302: The network nodes 160a, 160b retrieve the status reports from the agent entities 300a:300K via the user equipment 170a:170K.

S303: The network nodes 160a, 160b provide the retrieved status reports to the server entity 200.

S304: The server entity 200, based on the receives status reports, divides the agent entities 300a:300K into at least two subsets, where each subsets is associated with its own MBSFN area. The server entity 200 further, based on the receives status reports, individually selects which transmission mode to use for each of the subsets. According to the illustrative example in FIG. 7, agent entities 300a, 300b belong to a first subset and agent entities 300k, 300K belong to a second subset.

S305: The server entity 200 configures the network nodes 160a, 160b with the MBSFN areas and configures the agent entities 300a:300K with which reception mode to use, depending on to which subset each of the agent entities 300a:300K belongs.

According to the illustrative example in FIG. 7, network node 160a serves a first MBSFN area and network node 160b serves a second MBSFN area. Agent entities 300a, 300b are served in the first MBSFN area and agent entities 300k, 300K are served in the second MBSFN area.

S306: The server entity 200 and the agent entities 300a:300K perform an iterative learning process in accordance with the configurations of MBSFN areas, transmission modes, and reception modes.

The communication network of FIG. 7 and the signalling diagram of FIG. 8 can be extended to more than two subsets, or MBSFN areas, as well as to not only using first-level differences for sending the parameter vector but also using second-level differences, etc. when the second transmission mode is used.

Non-limiting examples of scenarios where the herein disclosed embodiments can be applied will be disclosed next.

According to a first example, the computational task pertains to prediction of best secondary carrier frequencies to be used by user equipment 170a:170K in which the agent entities 300a:300K are provided. The data locally obtained by the agent entity 300k can then represent a measurement on a serving carrier of the user equipment 170k. In this respect, the best secondary carrier frequencies for user equipment 170a:170K can be predicted based on their measurement reports on the serving carrier. The secondary carrier frequencies as reported thus defines the computational result. In order to enable such a mechanism, the agent entities 300a:300K can be trained by the server entity 200, where each agent entity 300k, according to the machine learning model, takes as input the measurement reports on the serving carrier(s) (among possibly other available reports such as timing advance, etc.) and as outputs a prediction of whether the user equipment 170k in which the agent entity 300k is provided has coverage or not in the secondary carrier frequency.

According to a second example, the computational task pertains to compressing channel-state-information using an auto-encoder, where the server entity 200 implements a decoder of the auto-encoder, and where each of the agent entities 300a:300K, according to the machine learning model, implements a respective encoder of the auto-encoder. An autoencoder can be regarded as a type of neural network used to learn efficient data representations.

According to a third example, the computational task pertains to signal quality drop prediction. The signal quality drop prediction is based on measurements on wireless links used by user equipment 170a:170K in which the agent entities 300a:300K are provided. In this respect, based on received data, in terms of computational results, in the reports, the server entity 200 can learn, for example, what sequence of signal quality measurements (e.g., reference signal received power; RSRP) that results in a large signal quality drop. After a machine learning model is trained, for instance using the iterative learning process, the server entity 200 can provide the model to the agent entities 300a:300K. The model can be provided either to agent entities 300a:300K having taken part in the training, or to other agent entities 300a:300K. The agent entities 300a:300K can then apply the model to predict future signal quality values. This signal quality prediction can then be used in the context of any of: initiating inter-frequency handover, setting handover and/or reselection parameters, changing device scheduler priority so as to schedule the user equipment 170a:170K when the expected signal quality is good. The data for training such a model is located at the device-side where the agent entities 300a:300K reside, and hence an iterative learning process as disclosed herein can be used to efficiently learn the future signal quality prediction.

According to a fourth example, the iterative learning procedure concerns mapping one or more geolocations to a radio signal quality values, or bitrate values. This can be used by the network to create an understanding of potential network coverage holes in a cell, and how the bitrate varies within the cell. However, a device-reported geolocation can violate privacy concerns of the user equipment, and therefore an iterative learning procedure can be used since it only comprises signaling of parameter vectors. As an illustrative example assume that agent entities 300a:300K have a dataset of geolocation to Signal-to-Interference-plus-Noise Ratio (SINR) mappings according to each respective dotted area (where the SINR takes a normalized value from 0 to 1). The agent entities 300a:300K then perform an iterative learning procedure with the server entity 200 in order to include their dataset information in a global machine learning model to be used by the network.

According to a fifth example, the iterative learning procedure concerns surveillance, using a network of cameras, of a particular area public or private). Each camera is associated with its own agent entity 300a:300K. The network is configured to learn a global machine learning model that can be used to detect whether suspicious activity is ongoing in any of the video imagery as captured by the cameras. The suspicious activity could pertain to identifying unauthorized persons present in a private area, identifying vehicles in the area, or monitoring the area for any criminal activity. The cameras however, for privacy reasons, are not allowed to share their raw image data. An iterative learning procedure can then be used to train the global machine learning model, where the cameras share only model (gradient) updates in terms of parameter vectors, rather than their observations. In this case the parameter vectors might represent predictions of the content in the images (for examples, parameters of a face recognition algorithm).

According to a sixth example, the iterative learning procedure concerns a natural language processing application. The agent entities 300a:300K could learn a language model that represents a machine learning model, for example for text prediction when typing on a user equipment 170a:170K, such as a mobile device, where each of the agent entities 300a:300K thus could be associated with their own user equipment 170a:170K. Using an iterative learning procedure, only updates to the model need to be shared, but raw text data will not be shared.

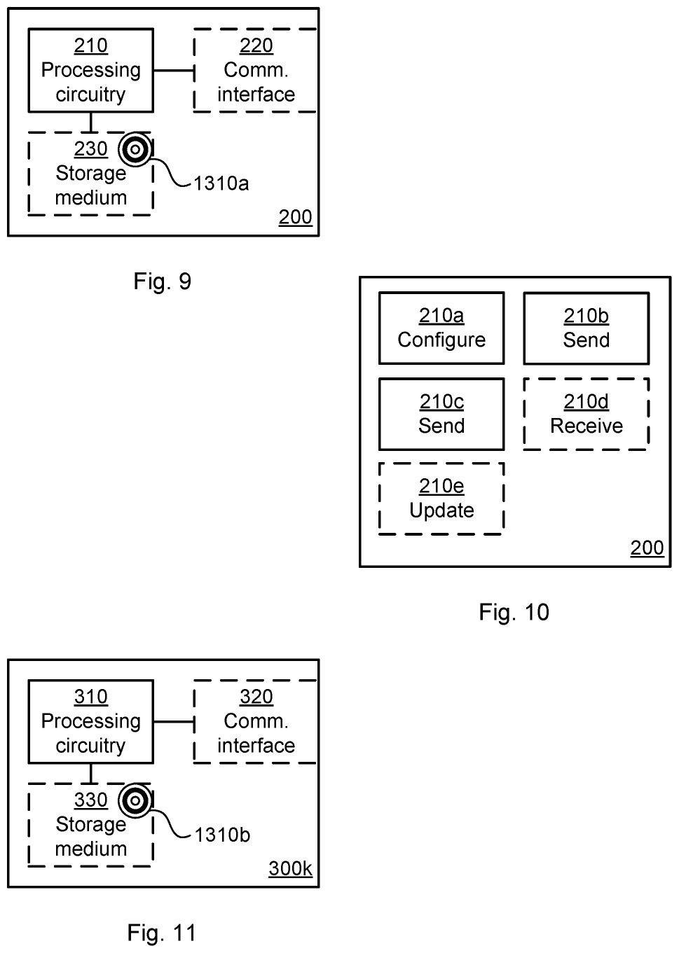

FIG. 9 schematically illustrates, in terms of a number of functional units, the components of a server entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310a (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the server entity 200 to perform a set of operations, or steps, as disclosed above. For example, the storage medium 230 may store the set of operations, and the processing circuitry 210 may be configured to retrieve the set of operations from the storage medium 230 to cause the server entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The server entity 200 may further comprise a communications interface 220 for communications with other entities, functions, nodes, and devices, either directly or indirectly. As such the communications interface 220 may comprise one or more transmitters and receivers, comprising analogue and digital components.

The processing circuitry 210 controls the general operation of the server entity 200 e.g. by sending data and control signals to the communications interface 220 and the storage medium 230, by receiving data and reports from the communications interface 220, and by retrieving data and instructions from the storage medium 230. Other components, as well as the related functionality, of the server entity 200 are omitted in order not to obscure the concepts presented herein.

FIG. 10 schematically illustrates, in terms of a number of functional modules, the components of a server entity 200 according to an embodiment. The server entity 200 of FIG. 10 comprises a number of functional modules; a configure module 210a configured to perform step S102, a (first) send module 210b configured to perform step S104a, and a (second) send module 210c configured to perform step S104b. The server entity 200 of FIG. 10 may further comprise a number of optional functional modules, such as any of a receive module 210d configured to perform optional step S106, and/or an update module 210e configured to perform optional step S108. In general terms, each functional module 210a:210e may be implemented in hardware or in software. Preferably, one or more or all functional modules 210a:210e may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210e and to execute these instructions, thereby performing any steps of the server entity 200 as disclosed herein.

The server entity 200 may be provided as a standalone device or as a part of at least one further device. For example, the server entity 200 may be provided in a node of the radio access network or in a node of the core network. Alternatively, functionality of the server entity 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the server entity 200 may be executed in a first device, and a second portion of the instructions performed by the server entity 200 may be executed in a second device; the herein disclosed embodiments are not limited to any particular number of devices on which the instructions performed by the server entity 200 may be executed. Hence, the methods according to the herein disclosed embodiments are suitable to be performed by a server entity 200 residing in a cloud computational environment. Therefore, although a single processing circuitry 210 is illustrated in FIG. 9 the processing circuitry 210 may be distributed among a plurality of devices, or nodes. The same applies to the functional modules 210a:210e of FIG. 10 and the computer program 1320a of FIG. 13.

FIG. 11 schematically illustrates, in terms of a number of functional units, the components of an agent entity 300k according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1310b (as in FIG. 13), e.g. in the form of a storage medium 330. The processing circuitry 310 may further be provided as at least one application specific integrated circuit (ASIC), or field programmable gate array (FPGA).

Particularly, the processing circuitry 310 is configured to cause the agent entity 300k to perform a set of operations, or steps, as disclosed above. For example, the storage medium 330 may store the set of operations, and the processing circuitry 310 may be configured to retrieve the set of operations from the storage medium 330 to cause the agent entity 300k to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The agent entity 300k may further comprise a communications interface 320 for communications with other entities, functions, nodes, and devices, either directly or indirectly. As such the communications interface 320 may comprise one or more transmitters and receivers, comprising analogue and digital components.

The processing circuitry 310 controls the general operation of the agent entity 300k e.g. by sending data and control signals to the communications interface 320 and the storage medium 330, by receiving data and reports from the communications interface 320, and by retrieving data and instructions from the storage medium 330. Other components, as well as the related functionality, of the agent entity 300k are omitted in order not to obscure the concepts presented herein.

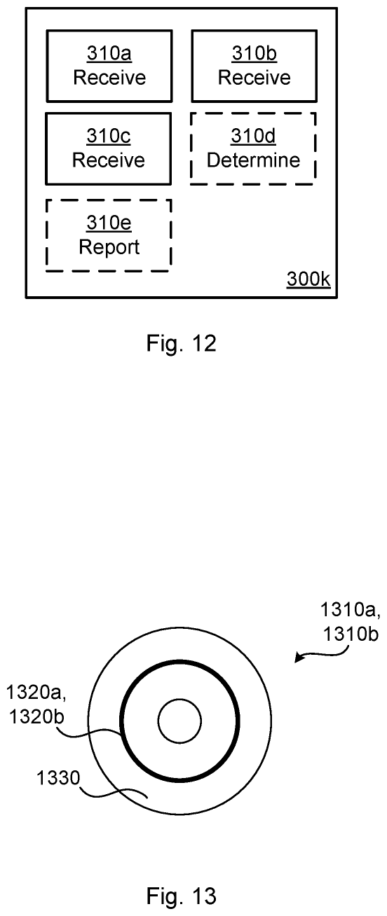

FIG. 12 schematically illustrates, in terms of a number of functional modules, the components of an agent entity 300k according to an embodiment. The agent entity 300k of FIG. 12 comprises a number of functional modules; a (first) receive module 310a configured to perform step S202, a (second) receive module 310b configured to perform step S204a, and a (third) receive module 310c configured to perform step S204b. The agent entity 300k of FIG. 12 may further comprise a number of optional functional modules, such as any of a determine module 310d configured to perform optional step S206, and/or a report module 310e configured to perform optional step S208. In general terms, each functional module 310a: 310e may be implemented in hardware or in software. Preferably, one or more or all functional modules 310a: 310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a: 310e and to execute these instructions, thereby performing any steps of the agent entity 300k as disclosed herein.

FIG. 13 shows one example of a computer program product 1310a, 1310b comprising computer readable means 1330. On this computer readable means 1330, a computer program 1320a can be stored, which computer program 1320a can cause the processing circuitry 210 and thereto operatively coupled entities and devices, such as the communications interface 220 and the storage medium 230, to execute methods according to embodiments described herein. The computer program 1320a and/or computer program product 1310a may thus provide means for performing any steps of the server entity 200 as herein disclosed. On this computer readable means 1330, a computer program 1320b can be stored, which computer program 1320b can cause the processing circuitry 310 and thereto operatively coupled entities and devices, such as the communications interface 320 and the storage medium 330, to execute methods according to embodiments described herein. The computer program 1320b and/or computer program product 1310b may thus provide means for performing any steps of the agent entity 300k as herein disclosed.

In the example of FIG. 13, the computer program product 1310a, 1310b is illustrated as an optical disc, such as a CD (compact disc) or a DVD (digital versatile disc) or a Blu-Ray disc. The computer program product 1310a, 1310b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320a, 1320b is here schematically shown as a track on the depicted optical disk, the computer program 1320a, 1320b can be stored in any way which is suitable for the computer program product 1310a, 1310b.

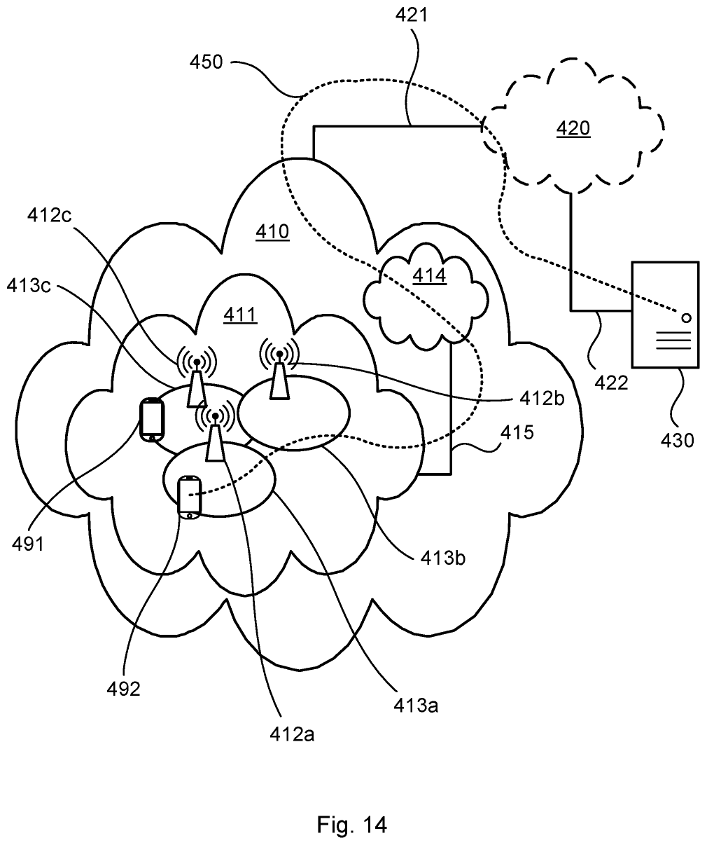

FIG. 14 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 160 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the UEs 170a:170K of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 14 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

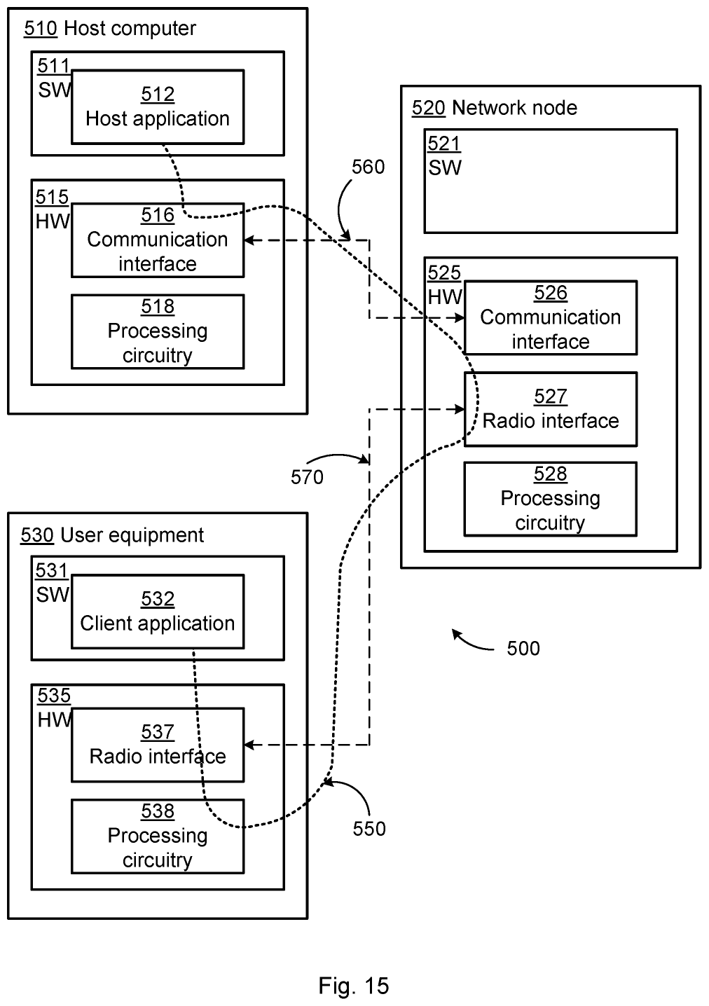

FIG. 15 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 15. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the UEs 170a:170K of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 160 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 15) served by radio access network node 520. Communication interface 526 may be configured to facilitate connection 560 to host computer 510. Connection 560 may be direct or it may pass through a core network (not shown in FIG. 15) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 15 may be similar or identical to host computer 430, one of network nodes 412a, 412b, 412c and one of UEs 491, 492 of FIG. 14, respectively. This is to say, the inner workings of these entities may be as shown in FIG. 15 and independently, the surrounding network topology may be that of FIG. 14.

In FIG. 15, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1.-38. (canceled)

39. A method for performing an iterative learning process with agent entities, wherein the method is performed by a server entity, wherein the iterative learning process pertains to a computational task to be performed by the agent entities, wherein for each iteration round of the iterative learning process the server entity uses either a first transmission mode or a second transmission mode for sending a respective parameter vector of the computational task towards the agent entities, wherein each of the first transmission mode and the second transmission mode has a corresponding reception mode, and wherein the method comprises:
configuring the agent entities with the computational task, with which reception mode to use, and for the agent entities to, as part of performing one iteration round of the iterative learning process with the server entity, send local updates of computational results of the computational task to the server entity;
sending the parameter vector of a first iteration round of the iterative learning process to the agent entities whilst using the first transmission mode as part of performing the first iteration round; and
sending the parameter vector of a second iteration round of the iterative learning process to the agent entities whilst using the second transmission mode as part of performing the second iteration round.

40. The method according to claim 39, wherein according to the first transmission mode the parameter vector is sent without reference to any parameter vector of any previous iteration round and/or according to the second transmission mode the parameter vector is sent as a difference to the parameter vector of at least one previous iteration round.

41. The method according to claim 39, wherein according to the second transmission mode the parameter vector is sent either as a first-level difference to the parameter vector of at least one previous iteration round or as a second-level difference to the first-level difference of said at least one previous iteration round.

42. The method according to claim 39, wherein according to the first transmission mode the parameter vector is sent using higher transmission power, and/or higher error protection using a more robust modulation and coding scheme than according to the second transmission mode.

43. The method according to claim 39, wherein the server entity periodically switches between the first transmission mode and the second transmission mode.

44. The method according to claim 39, wherein which of the first transmission mode and the second transmission mode to use for a given iteration round of the iterative learning process is by the server entity selected as a function of at least one obtained parameter.

45. The method according to claim 44, wherein:
the at least one parameter pertains to properties of a propagation channel between the server entity and the agent entities;
the at least one parameter pertains to status reports received from the agent entities, wherein the status report from a given agent entity indicates the parameter vector most recently received by said given agent entity, convergence of the computational task, and/or whether said given agent entity has been able to correctly decode the parameter vector most recently sent by the server entity; and/or
each of the agent entities is associated with a data importance score, and the at least one parameter pertains to how many of the agent entities with data importance score higher than a threshold value that have failed to correctly decode the parameter vector most recently sent by the server entity using the second transmission mode.

46. The method according to claim 39, wherein which of the first transmission mode and the second transmission mode to use for each of the iteration rounds is:
individually selected per each of the iteration rounds; or
collectively selected for at least two iteration rounds; or
individually selected per each of at least two subsets into which the agent entities are divided.

47. The method according to claim 39, wherein the second transmission mode is used for at least two consecutive iteration rounds, and/or wherein for how many consecutive iteration rounds the second transmission mode is used depends on the at least one parameter.

48. A method for performing an iterative learning process with a server entity, wherein the method is performed by an agent entity, wherein the iterative learning process pertains to a computational task to be performed by the agent entity, wherein for each iteration round of the iterative learning process the agent entity uses either a first reception mode or a second reception mode for receiving a respective parameter vector of the computational task from the server entity, and wherein the method comprises:
receiving configuration from the server entity of the computational task, of which reception mode to use, and for the agent entity to, as part of performing one iteration round of the iterative learning process with the server entity, send a local update of computational results of the computational task to the server entity;
receiving the parameter vector of a first iteration round of the iterative learning process from the server entity whilst using the first reception mode as part of performing the first iteration round; and
receiving the parameter vector of a second iteration round of the iterative learning process from the server entity whilst using the second reception mode as part of performing the second iteration round.

49. The method according to claim 48, wherein according to the first reception mode the parameter vector is received without reference to any parameter vector of any previous iteration round and/or wherein according to the second reception mode the parameter vector is received as a difference to the parameter vector of at least one previous iteration round.

50. The method according to claim 48, wherein according to the second reception mode the parameter vector is received either as a first-level difference to the parameter vector of at least one previous iteration round or as a second-level difference to the first-level difference of said at least one previous iteration round.

51. The method according to claim 48, wherein according to the configuration from the server entity, the agent entity is to periodically switch between the first reception mode and the second reception mode.

52. The method according to claim 48, wherein according to the configuration from the server entity, the agent entity is requested to send a status report to the server entity, wherein the status report indicates the parameter vector most recently received by the agent entity, convergence of the computational task, and/or whether the agent entity has been able to correctly decode the parameter vector most recently received from the server entity.

53. The method according to claim 48, wherein the configuration of which reception mode to use is received:
per each of the iteration rounds; or
per at least two iteration rounds.

54. The method according to claim 48, wherein the second reception mode is used for at least two consecutive iteration rounds and/or wherein for how many consecutive iteration rounds the second reception mode is used depends on the status report.

55. The method according to claim 48, wherein the server entity and the agent entities are provided in a distributed computing architecture.

56. The method according to claim 48, wherein the server entity is provided in a network node, and each of the agent entities is provided in a respective user equipment.

57. A server entity for performing an iterative learning process with agent entities, wherein the iterative learning process pertains to a computational task to be performed by the agent entities, wherein for each iteration round of the iterative learning process the server entity is to use either a first transmission mode or a second transmission mode for sending a respective parameter vector of the computational task towards the agent entities, wherein each of the first transmission mode and the second transmission mode has a corresponding reception mode, wherein the server entity comprises:
processing circuitry, the processing circuitry being configured to cause the server entity to:
configure the agent entities with the computational task, with which reception mode to use, and for the agent entities to, as part of performing one iteration round of the iterative learning process with the server entity, send local updates of computational results of the computational task to the server entity;
send the parameter vector of a first iteration round of the iterative learning process to the agent entities whilst using the first transmission mode as part of performing the first iteration round; and
send the parameter vector of a second iteration round of the iterative learning process to the agent entities whilst using the second transmission mode as part of performing the second iteration round.

58. An agent entity for performing an iterative learning process with a server entity, wherein the iterative learning process pertains to a computational task to be performed by the agent entity, wherein for each iteration round of the iterative learning process the agent entity is to use either a first reception mode or a second reception mode for receiving a respective parameter vector of the computational task from the server entity, wherein the agent entity comprises:
processing circuitry, the processing circuitry being configured to cause the agent entity to:
receive configuration from the server entity of the computational task, of which reception mode to use, and for the agent entity to, as part of performing one iteration round of the iterative learning process with the server entity, send a local update of computational results of the computational task to the server entity;
receive the parameter vector of a first iteration round of the iterative learning process from the server entity whilst using the first reception mode as part of performing the first iteration round; and
receive the parameter vector of a second iteration round of the iterative learning process from the server entity whilst using the second reception mode as part of performing the second iteration round.
